(19) United States
(12) Patent Application Publication
(10) Pub. No.: US 2026/0079525 A1
(43) Pub. Date: Mar. 19, 2026

(54) REAL-TIME VALUE GENERATION MODULE, OPERATION METHOD THEROF, AND ELECTRONIC DEVICE INCLUDING THE SAME

(71) Applicant: SAMSUNG ELECTRONICS CO., LTD., Suwon-si (KR)

(72) Inventors: Dongsik Cho, Suwon-si (KR); Kangtae Cho, Suwon-si (KR)

(73) Assignee: SAMSUNG ELECTRONICS CO., LTD., Suwon-si (KR)

(21) Appl. No.: 19/176,965

(22) Filed: Apr. 11, 2025

(30) Foreign Application Priority Data
Sep. 13, 2024 (KR) 10-2024-0126094

(51) Int. Cl. G06F 1/06

(52) U.S. Cl. CPC G06F 1/06

(57) ABSTRACT

An electronic device is provided. The electronic device includes: a clock signal generation circuit configured to generate a first clock signal of a first period and a second clock signal of a second period, and to selectively output one of the first clock signal and the second clock signal; a time count circuit configured to increase a time gray code in response to the first clock signal and decrease the time gray code in response to the second clock signal; and a function circuit configured to generate a real-time value based on the time gray code.

### CROSS-REFERENCE TO RELATED APPLICATION

This application claims priority to Korean Patent Application No. 10-2024-0126094, filed on Sep. 13, 2024, in the Korean Intellectual Property Office, the disclosure of which is incorporated by reference herein in its entirety.

### BACKGROUND

The present disclosure relates to a semiconductor device, and more particularly, relate to a real-time value generation circuit, an operating method thereof, and an electronic device including the same.

In an operation of a System-on-Chip (SoC), obtaining a real-time value may be required. For example, the SoC may obtain a real-time value based on a value obtained by accumulating the received clock signal. It is required that a difference or error between real-time values generated by each SoC in response to the clock signal is small.

The SoC may have two or more modes to reduce power consumption, and the period of the clock signal used for each mode may be different. Even when the period of the clock signal changes, the SoC is required to obtain a real-time value identical to real time, regardless of period changes of the clock signal.

### SUMMARY

One or more example embodiments provide a real-time value generation module capable of consistently generating a real-time value even when the period of the clock signal changes, an operating method thereof, and an electronic device including the same.

According to an aspect of an example embodiment, an electronic device includes: a clock signal generation circuit configured to generate a first clock signal of a first period and a second clock signal of a second period, and to selectively output one of the first clock signal and the second clock signal; a time count circuit configured to increase a time gray code in response to the first clock signal and decrease the time gray code in response to the second clock signal; and a function circuit configured to generate a real-time value based on the time gray code.

According to another aspect of an example embodiment, a real-time value generation device that real-time value generation device configured to generate a real-time value, includes: a code conversion circuit configured to convert a time gray code including a plurality of bits into a time binary code; a difference detection circuit configured to generate an increase event signal in response to detecting an increase in the time gray code and a decrease event signal in response to detecting a decrease in the time gray code; a decrease event count circuit configured to identify a number of decrease events indicating a number of times the time gray code decreases, according to the decrease event signal; and an accumulation circuit configured to generate the real-time value based on the number of decrease events. The time gray code increases in response to a first clock signal of a first period, and decreases in response to a second clock signal of a second period.

According to another aspect of an example embodiment, an operating method of a real-time value generation device configured to manage a real-time value, includes: receiving a time gray code that increases in response to a first clock signal of a first period and decreases in response to a second clock signal of a second period; converting the time gray code into a time binary code indicating a same value; detecting a change in the time gray code; detecting a number of increase events indicating a number of times the time gray code increases, and a number of decrease events indicating a number of times the time gray code decreases; and changing the real-time value based on the number of increase events and the number of decrease events.

According to another aspect of an example embodiment, an operating method of a real-time value generation device configured to generate a real-time value, includes: receiving a time gray code that increases in response to a first clock signal of a first period and decreases in response to a second clock signal of a second period; converting the time gray code into a time binary code indicating a same value; detecting a change in the time gray code; increasing the real-time value by a first interval based on the change indicating an increase in the time gray code; and increasing the real-time value by a second interval based on the change indicating a decrease in the time gray code.

According to another aspect of an example embodiment, a real-time value generation device configured to generate a real-time value, includes: a code conversion circuit configured to convert a time gray code into a time binary code, wherein the time gray code includes a plurality of bits, increases in response to a first clock signal of a first period and decreases into a second clock signal of a second period; a difference detection circuit configured to generate a difference signal based on a change in the time gray code; and a time value generation circuit configured to increase the real-time value by a second interval corresponding to the second period based on the difference signal indicating a decrease in the time gray code.

According to another aspect of an example embodiment, an electronic device includes: a clock signal generation circuit configured to generate a first clock signal of a first period and a second clock signal of a second period, and to selectively output one of the first clock signal and the second clock signal; a time count circuit configured to increase a time gray code in response to the first clock signal and decrease the time gray code in response to the second clock signal; and a function circuit configured to generate a real-time value based on the time gray code. The time gray code includes a plurality of bits. The function circuit is further configured to: identify a number of increase events indicating a number of times the time gray code increases, and a number of decrease events indicating a number of times the time gray code decreases; and generate the real-time value based on the number of increase events and the number of decrease events.

### BRIEF DESCRIPTION OF DRAWINGS

The above and other aspects and features will be more apparent from the following description of example embodiments, taken in conjunction with the accompanying drawings, in which:

FIG. 1 is a block diagram illustrating an electronic device, according to an example embodiment;

FIG. 2 is a diagram showing an example of a time gray code according to an operation of the time count block of FIG. 1, according to an example embodiment;

FIG. 3A is a graph showing an example of an operation of the time count block of FIG. 1, according to an example embodiment, and FIG. 3B is a graph showing an example of an operation of the real-time value generation module of FIG. 1, according to an example embodiment;

FIG. 4A is a graph showing an example of an operation of the time count block of FIG. 1, according to an example embodiment, and FIG. 4B is a graph showing an example of an operation of the real-time value generation module of FIG. 1, according to an example embodiment;

FIG. 5A is a graph showing an example of an operation of the time count block of FIG. 1, according to an example embodiment, and FIG. 5B is a graph showing an example of an operation of the real-time value generation module of FIG. 1, according to an example embodiment;

FIG. 6 is a flowchart showing an example of an operating method of the time count block of FIG. 1, according to an example embodiment;

FIG. 7 is a flowchart showing an example of an operating method of the real-time value generation module of FIG. 1, according to an example embodiment;

FIG. 8 is a block diagram showing in detail an example of a clock signal generation block of FIG. 1, according to an example embodiment;

FIG. 9 is a block diagram showing in detail an example of a real-time value generation module of FIG. 1, according to an example embodiment;

FIG. 10 is a block diagram showing in detail an example of a real-time value generation module of FIG. 1, according to an example embodiment;

FIG. 11 is a flowchart showing an example of an operating method of the real-time value generation module of FIG. 10, according to an example embodiment; and

FIG. 12 is a block diagram illustrating an electronic device according to an example embodiment.

### DETAILED DESCRIPTION

Hereinafter, example embodiments will be described with reference to the drawings. As used throughout the detailed description, components described with reference to the terms “module”, “block”, “˜er or ˜or”, etc., and function blocks illustrated in drawings may be implemented with hardware. For example, the hardware may include an electrical circuit, an electronic circuit (an analog circuit or a digital circuit), a processor, a computer, an integrated circuit, integrated circuit cores, a pressure sensor, an inertial sensor, a microelectromechanical system (MEMS), a passive element, or a combination thereof.

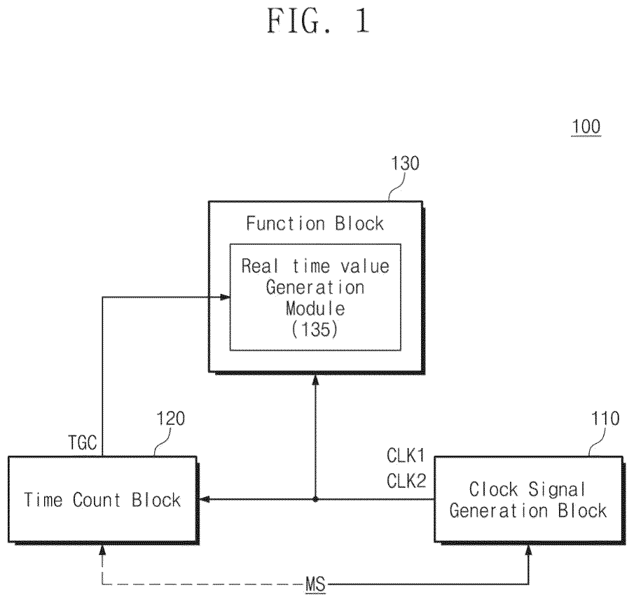

FIG. 1 is a block diagram illustrating an electronic device, according to an example embodiment. Referring to FIG. 1, an electronic device 100 may include a clock signal generation block (i.e., clock signal generation circuit) 110, a time count block (i.e., time count circuit) 120, and a function block (i.e., function circuit) 130. The electronic device 100 may be various devices or may be included in various devices. For example, the electronic device 100 may be a personal computer (PC), a laptop PC, a smartphone, a tablet PC, a personal digital assistant (PDA), a server, a datacenter, or the like, or may be included therein. In an example embodiment, the electronic device 100 may be a SoC. In an example embodiment, the electronic device 100 may be a processing device. For example, the electronic device 100 may be a general-purpose processor such as a central processing unit (CPU) or an application processor (AP), or an accelerator such as a graphics processing unit (GPU), a neural processing unit (NPU), a neuromorphic processor (NP), or a tensor processing unit (TPU).

The clock signal generation block 110 may generate a clock signal (CLK1, CLK2). The clock signal (CLK1, CLK2) may be used for an operation of the electronic device 100, or may be a signal that serves as a reference of the operation. In an example embodiment, the clock signal generation block 110 may generate the clock signal (CLK1, CLK2) having a plurality of periods. For example, the clock signal generation block 110 may generate the first clock signal CLK1 having a first period and the second clock signal CLK2 having a second period. The first period and the second period may be different periods from each other.

In an example embodiment, the clock signal generation block 110 may determine the period of the clock signal based on the operating mode of the electronic device 100. For example, the clock signal generation block 110 may generate the first clock signal CLK1 having the first period in a first mode (e.g., a normal mode), and may generate the second clock signal CLK2 having the second period in a second mode (e.g., a sleep mode). Here, the second period may be a longer time than the first period.

In an example embodiment, the clock signal generation block 110 may further generate a clock signal having a period other than the first clock signal CLK1 and the second clock signal CLK2. In an example embodiment, the clock signal generation block 110 may select the clock signal (CLK1, CLK2) output in response to a mode signal MS. The mode signal MS may indicate an operating mode of the electronic device 100, or may indicate the clock signal (CLK1, CLK2) to be output by the clock signal generation block 110. In an example embodiment, the mode signal MS may be generated by one or more of various blocks of the electronic device 100, such as the function block 130 or the power management block. For example, the clock signal generation block 110 may output the first clock signal CLK1 in response to the mode signal MS.

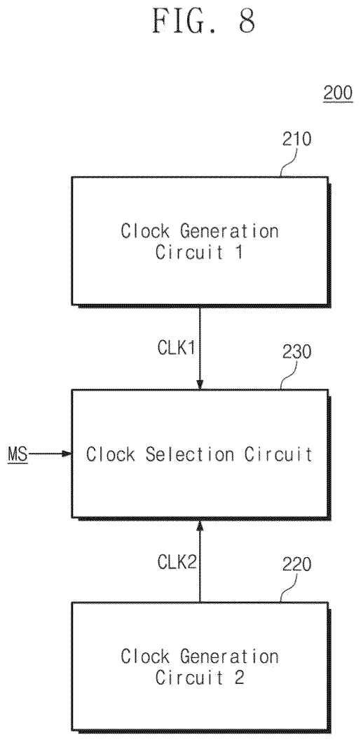

In an example embodiment, the clock signal generation block 110 may transmit the generated clock signal (CLK1, CLK2) to other configurations of the electronic device 100. For example, the clock signal generation block 110 may transmit the clock signal (CLK1, CLK2) to the time count block 120 and the function block 130. The clock signal generation block 110 is described in more detail with reference to FIG. 8.

The time count block 120 may count the clock signal (CLK1, CLK2) and may generate a time gray code TGC. For example, counting a clock signal may refer to an operation of counting rising or falling edges of the clock signal. The time gray code TGC may include a plurality of bits corresponding to a real-time value, and the plurality of bits may have the format of a gray code. For example, the time gray code TGC may be a gray code of 16-bit length. In an example embodiment, the time count block 120 may change or update the time gray code TGC by counting the clock signal (CLK1, CLK2). For example, the time count block 120 may increase or decrease the time gray code TGC by a predetermined amount in response to the rising edge of the clock signal (CLK1, CLK2). For example, the time count block 120 may increase or decrease the time gray code TGC by a predetermined amount in response to the falling edge of the clock signal (CLK1, CLK2).

In an example embodiment, the time count block 120 may generate the time gray code TGC based on a clock signal having the period of one of the clock signals CLK1 and CLK2. For example, the time count block 120 may generate the time gray code TGC based on the first clock signal CLK1 having the first period. In this regard, when the time count block 120 updates the time gray code TGC by counting the first clock signal CLK1, a number of flipped bits of the time gray code TGC may be one. When the time count block 120 updates the time gray code TGC by counting a clock signal other than the first clock signal CLK1, the number of flipped bits of the time gray code TGC may be more than one.

In an example embodiment, the time count block 120 may determine the type of the received clock signal (CLK1, CLK2) based on the timing of the occurrence of the next rising edge after the rising edge of the clock signal (CLK1, CLK2). For example, when the next rising edge is detected within a specific time interval after the rising edge of the clock signal (CLK1, CLK2), the time count block 120 may determine that the clock signal CLK1 having the first period is received. For another example, when the next rising edge is detected outside a specific time interval after the rising edge of the clock signal (CLK1, CLK2), the time count block 120 may determine that the clock signal CLK2 having the second period is received. An example embodiment, in which the time count block 120 determines that the first clock signal CLK1 is received when the next rising edge is detected within a specific interval, is an example, and the scope of the present disclosure should not be construed as being limited thereto.

In an example embodiment, the time count block 120 may further receive the mode signal MS. In this case, the time count block 120 may determine the type of the received clock signal (CLK1, CLK2) based on the mode signal MS. For example, when receiving the mode signal MS indicating the first mode (e.g., the normal mode), the time count block 120 may determine that the received clock signal (CLK1, CLK2) is the first clock signal CLK1. The first clock signal CLK1 is described as corresponding to the normal mode, but this is an example. The present disclosure is not limited thereto.

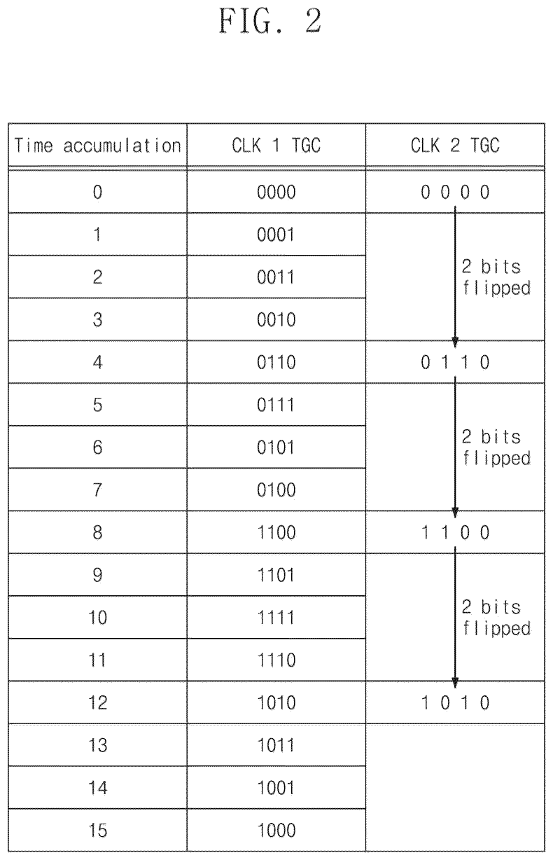

The time count block 120 may transmit the generated time gray code TGC to other components of the electronic device 100. For example, the time count block 120 may transmit the generated time gray code TGC to a real-time value generation module (i.e., real-time value generation circuit or real-time value generation device) 135 of the function block 130. The time count block 120 is described in more detail with reference to FIGS. 2 to 6.

The function block 130 may perform one or more operations or one or more functions of the electronic device 100. In an example embodiment, the function block 130 may be a functional unit of the electronic device 100. For example, the function block 130 may operate as a main processor of the electronic device 100.

In an example embodiment, the function block 130 may be or include a processor. For example, the function block 130 may be an application processor (AP) or may include an AP. In an example embodiment, the function block 130 may be implemented based on any hardware architecture. For example, the function block 130 may be implemented as an application specific integrated circuit (ASIC) or a field programmable gate array (FPGA). The function block 130 may include the real-time value generation module 135.

The real-time value generation module 135 may generate a real-time value. The real-time value may be a value corresponding to the real time during which the electronic device 100 operates. In an example embodiment, the real-time value generation module 135 may generate the real-time value in response to a time gray code. For example, the real-time value generation module 135 may generate the real-time value by converting the time gray code to a binary code. The real-time value generation module 135 is described in more detail with reference to FIGS. 2 to 5B, 7, and 9 to 11.

In FIG. 1, the configurations of the electronic device 100 are examples. It should be understood that an example embodiment further including configurations, or an example embodiment not including some of the illustrated configurations is also within the scope of the present disclosure. For example, the electronic device 100 may further include a memory device (e.g., a dynamic random access memory (DRAM)) that stores data generated by an operation. FIG. 1 illustrates that the time count block 120 is located outside the clock signal generation block 110, but the scope of the present disclosure is not limited thereto. In an example embodiment, the clock signal generation block 110 may include the time count block 120.

As the clock signal (CLK1, CLK2) may have a plurality of periods, the change amount of the time gray code TGC generated in response to the clock signal (CLK1, CLK2) may vary depending on the period of the clock signal (CLK1, CLK2). For example, the change amount of the time gray code TGC responding to the clock signal (CLK1, CLK2) of the first period may be 1, and the change amount of the time gray code TGC responding to the clock signal (CLK1, CLK2) of the second period may be a value greater than or equal to 2. In this case, the time gray code TGC responding to the clock signal (CLK1, CLK2) of the second period may not be expressed by a change of 1 bit, but may be expressed by a change of 2 or more bits. When the time gray code TGC is changed by 2 bits or more at a time, an error may occur due to a difference in time points or time periods at which each of a plurality of bits of the time gray code TGC arrives from the time count block 120 to the real-time value generation module 135. Hereinafter, the time count block 120 and the real-time value generation module 135, which may generate a real-time value without an error in response to the clock signal (CLK1, CLK2) of a plurality of periods, are described.

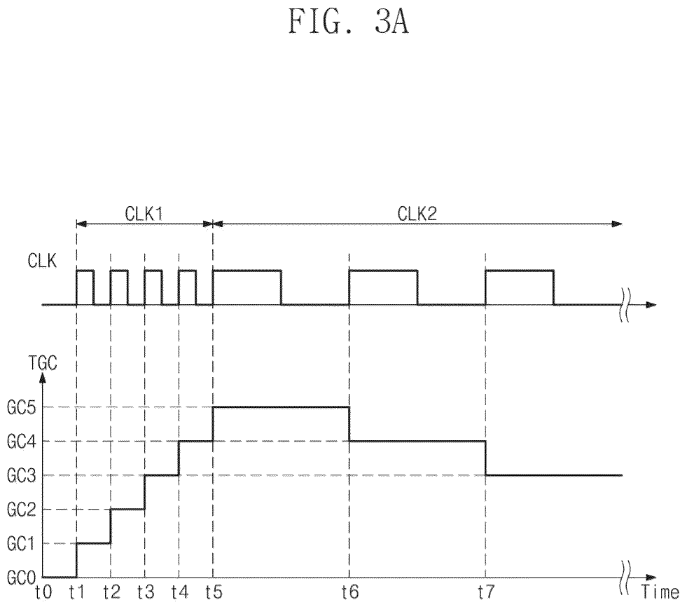

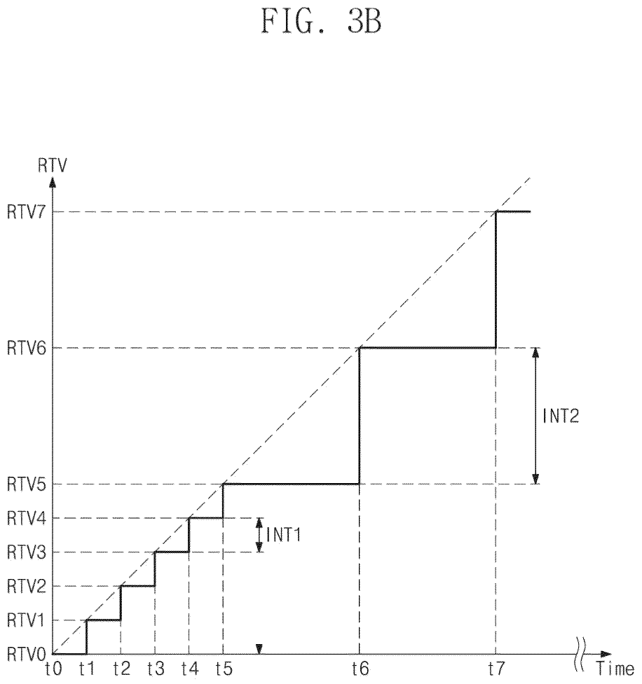

FIG. 2 is a diagram showing an example of a time gray code according to an operation of the time count block of FIG. 1, according to an example embodiment. Referring to FIG. 2, a time accumulation value, the time gray code TGC by the first clock signal CLK1, and the time gray code TGC by the second clock signal CLK2 are shown. The first clock signal CLK1 may be a clock signal having a first period, and the second clock signal CLK2 may be a clock signal having a second period. The second period may be longer than the first period. The time accumulation value may correspond to a real-time value (e.g., a real-time value RTV in FIG. 3B). For example, the second period may be four times the first period, but the scope of the present disclosure is not limited thereto.

In FIG. 2, the time gray code TGC may be a gray code of a 4-bit length. In an example embodiment, the gray code responding to the first clock signal CLK1 may change from ‘0000’ to ‘1000’ in response to 16 rising edges of the first clock signal CLK1. For example, the time gray code TGC may be initially ‘0000’, and the time gray code TGC responding to the eighth rising edge of the first clock signal CLK1 may be ‘1100’.

As the period of the second clock signal CLK2 is four times the period of the first clock signal CLK1, one rising edge of the second clock signal CLK2 may be generated for every four rising edges of the first clock signal CLK1. In an example embodiment, with respect to the same time accumulation value, the time gray code TGC by the second clock signal CLK2 may be the same as the time gray code TGC by the first clock signal CLK1. For example, the time gray code TGC by the first clock signal CLK1 and the second clock signal CLK2 corresponding to the time accumulation value of 4 may both be 0110.

Referring to the time gray code TGC by the second clock signal CLK2, the time gray code TGC may be ‘0000’ initially and may change in the order of ‘0110’, ‘1100’, and ‘1010’. When the time gray code TGC by the second clock signal CLK2 changes, the time gray code TGC may change by 2 bits. The time gray code TGC in FIG. 2 is an example and the scope of the present disclosure is not limited thereto. It should be understood that an example embodiment, in which the time gray code TGC has lengths other than 4 bits is also within the scope of the present disclosure. For example, the time gray code TGC may have a length of 32 bits.

Referring to FIGS. 1 and 2, in an example embodiment, the time count block 120 may transmit a plurality of bits to the real-time value generation module 135 at one time. For example, the time count block 120 and the real-time value generation module 135 may be connected through a plurality of signal lines. When several bits change in a single update of the time gray code TGC, the real-time value generation module 135 may fail to detect the correct time gray code TGC accurately due to the difference (e.g., the skew between bits) in timing at which each bit is transmitted to the real-time value generation module 135. That is, when the period of the clock signal (CLK1, CLK2) received by the real-time value generation module 135 changes due to a change in the mode of the electronic device 100, an error may occur in the generation of the real-time value.

The time count block 120 and the real-time value generation module 135 are connected through a plurality of signal lines and one bit is transmitted per signal line. However, the scope of the present disclosure is not limited thereto. In an example embodiment, the time count block 120 and the real-time value generation module 135 may be connected through one or more signal lines, and the time count block 120 may sequentially transmit a plurality of bits to the real-time value generation module 135 through at least some or all of the signal lines. A time count block and a real-time value generation module, which may generate a real-time value without an error even when the period of the clock signal (CLK1, CLK2) changes, an operating method thereof, and an electronic device including the same are described with reference to the drawings below.

FIG. 3A is a graph showing an example of an operation of the time count block of FIG. 1, according to an example embodiment. FIG. 3B is a graph showing an example of an operation of the real-time value generation module of FIG. 1, according to an example embodiment. Referring to FIGS. 3A and 3B, a horizontal axis may indicate time, and a vertical axis may indicate a signal or a value. According to an example embodiment, an operation of the time count block 120 and an operation of the real-time value generation module 135 are described with reference to FIGS. 1, 3A, and 3B. Among gray codes GC0 to GC5 of FIG. 3A, adjacent gray codes may be different from only one bit among a plurality of bits.

Referring to FIGS. 1 and 3A, an example of the clock signal (CLK1, CLK2) generated by the clock signal generation block 110 is shown. The clock signal generation block 110 may generate the first clock signal CLK1 having a first period until a fifth time point t5, and may generate the second clock signal CLK2 having a second period from the fifth time point t5. The second period may be longer than the first period. That is, the fifth time point t5 may be a mode switching time point of the clock signal generation block 110 or the electronic device 100.

Referring to FIGS. 1 and 3A, the time gray code TGC generated by the time count block 120 in response to the clock signal (CLK1, CLK2) is shown. In an example embodiment, the time count block 120 may increase or decrease the time gray code TGC depending on the period of the clock signal (CLK1, CLK2) or the mode of the electronic device 100. For example, in FIG. 3A, when changing or updating the time gray code TGC in response to the first clock signal CLK1, the time count block 120 may increase the time gray code TGC, and when changing or updating the time gray code TGC in response to the second clock signal CLK2, the time count block 120 may decrease the time gray code TGC.

In FIG. 3A, at an initial time point t0 the value of the time gray code TGC may be the initial gray code GC0. At a first time point t1, the value of the time gray code TGC may be changed to the first gray code GC1 in response to the rising edge of the first clock signal CLK1. The first gray code GC1 may be a value in which only one bit is different from the initial gray code GC0. The value of the time gray code TGC may be changed or updated at every rising edge of the first clock signal CLK1 until the fifth time point t5, and may be the fifth gray code GC5 at the fifth time point t5.

At the fifth time point t5, as the mode of the clock signal (CLK1, CLK2) change, the time count block 120 may change or update the time gray code TGC in response to the second clock signal CLK2. The time count block 120 may decrease the time gray code TGC in response to the second clock signal CLK2.

At a sixth time point t6, the time count block 120 may change the value of the time gray code TGC from the fifth gray code GC5 to the fourth gray code GC4 in response to the rising edge of the second clock signal CLK2. The fourth gray code GC4 may be a value in which only one bit is different from the fifth gray code GC5. Likewise, at a seventh time point t7, the time count block 120 may change the value of the time gray code TGC from the fourth gray code GC4 to the third gray code GC3 in response to the rising edge of the second clock signal CLK2.

Referring to FIGS. 1 and 3B, in FIG. 3B, the real-time value RTV generated by the real-time value generation module 135 of FIG. 1 is illustrated. In an example embodiment, the real-time value generation module 135 may generate the real-time value RTV based on the time gray code TGC. In an example embodiment, the real-time value generation module 135 may change or update the real-time value RTV depending on changes in the time gray code TGC. For example, when the time gray code TGC increases compared to the previous value, the real-time value generation module 135 may increase the real-time value RTV by a first interval INT1, and when the time gray code TGC decreases compared to the previous value, the real-time value generation module 135 may increase the real-time value RTV by a second interval INT2. In an example embodiment, the first interval INT1 may be equal to the period of the first clock signal CLK1 or may correspond to the period of the first clock signal CLK1. In an example embodiment, the second interval INT2 may be equal to the period of the second clock signal CLK2 or may correspond to the period of the second clock signal CLK2.

In FIG. 3B, the real-time value RTV may initially have an initial real-time value RTV0. At the first time point t1, the real-time value RTV may change to a first real-time value RTV1 in response to an increase in the time gray code TGC. The first interval INT1 between the first real-time value RTV1 and the initial real-time value RTV0 may correspond to the period of the first clock signal CLK1. The real-time value RTV may increase by the first interval depending on the change of the time gray code TGC value until immediately after the fifth time point t5, and may have the fifth real-time value RTV5 at the fifth time point t5. Likewise, the real-time value RTV may increase by the second interval INT2 from the sixth time point t6, and have a seventh real-time value RTV7 at the seventh time point t7. In FIG. 3B, as the relationship between the real-time value RTV and time is illustrated by a dotted line, the real-time value generation module 135 may generate the real-time value RTV corresponding to (or matching) the real time based on the time gray code TGC of FIG. 3A.

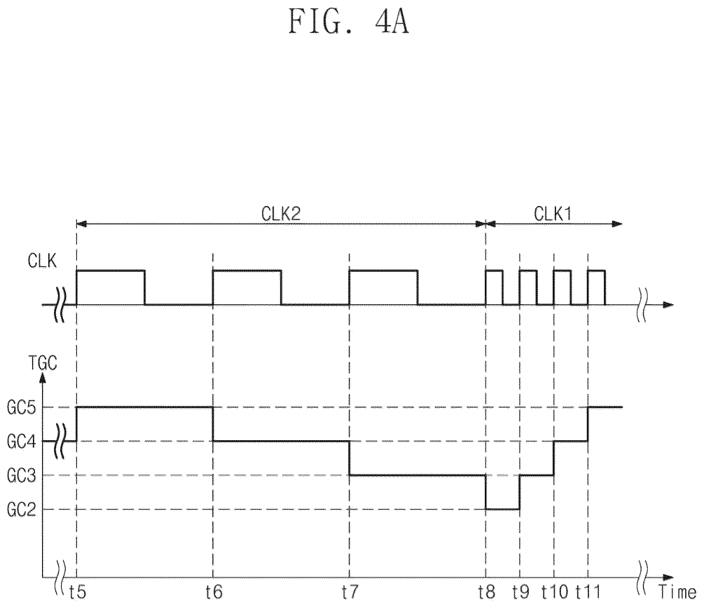

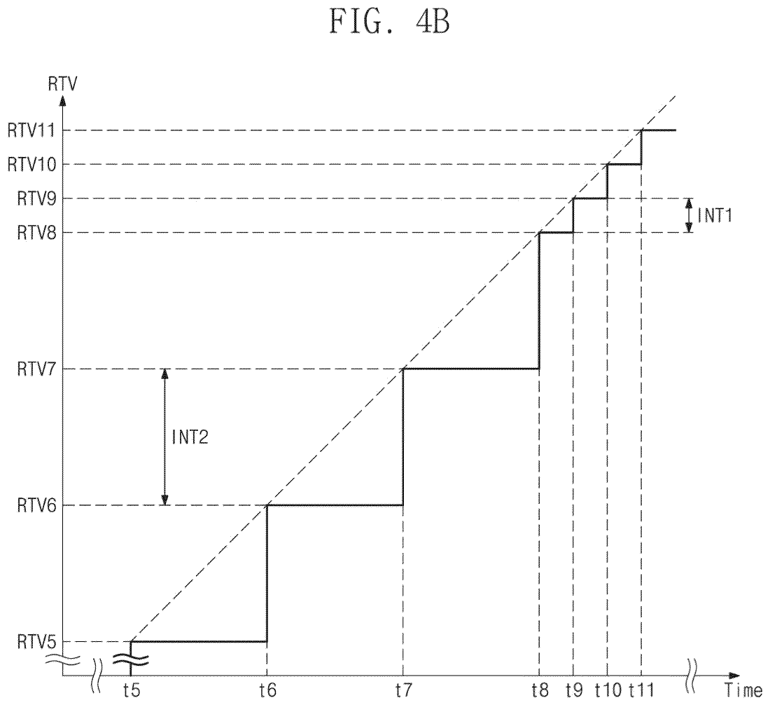

FIG. 4A is a graph showing an example of an operation of the time count block of FIG. 1, according to an example embodiment. FIG. 4B is a graph showing an example of an operation of the real-time value generation module of FIG. 1, according to an example embodiment. FIG. 4A and FIG. 4B may be operations of the time count block 120 and the real-time value generation module 135 after the fifth time point t5 of FIG. 3A and FIG. 3B. Referring to FIGS. 4A and 4B, a horizontal axis may indicate time, and a vertical axis may indicate a signal or a value. Among the gray codes GC2 to GC5 in FIG. 4A, adjacent gray codes may be different from only one bit among a plurality of bits.

Referring to FIG. 1, FIG. 3A and FIG. 4A, as the clock signal (CLK1, CLK2) received by the time count block 120 from the clock signal generation block 110 is the second clock signal CLK2, the time count block 120 may decrease the time gray code TGC. For example, the time gray code TGC at the fifth time point t5 may be the fifth gray code GC5. The time gray code TGC may be updated to the fourth gray code GC4 in response to the rising edge of the second clock signal CLK2 at the sixth time point t6. Here, the fourth gray code GC4 may be different from the fifth gray code GC5 by only one bit, and may be a value as small as 1.

The time gray code TGC may decrease up to an eighth time point t8, at which the mode of the clock signal (CLK1, CLK2) changes, and may be updated to the second gray code GC2 at the eighth time point t8. At the eighth time point t8, the mode of the clock signal (CLK1, CLK2) may be changed from the mode of the second clock signal CLK2 to the mode of the first clock signal CLK1. At the eighth time point t8, the time count block 120 may decrease the time gray code TGC in response to the rising edge of the first clock signal CLK1.

In response to the rising edge of the first clock signal CLK1, the time count block 120 may increase the time gray code TGC and may update the time gray code TGC to the third gray code GC3 at a ninth time point t9. In response to the rising edge of the first clock signal CLK1, the time count block 120 may update the time gray code TGC up to the fifth gray code GC5 at an eleventh time point t11. Like the fifth time point t5 in FIG. 3A, as the mode of the clock signal (CLK1, CLK2) changes, the time count block 120 may change a method of updating the time gray code TGC. For example, the time count block 120 may update the time gray code TGC based on decreasing the time gray code TGC in response to the second clock signal CLK2 from the fifth time point t5 to the eighth time point t8, and may update the time gray code TGC based on increasing the time gray code TGC in response to the first clock signal CLK1 from the ninth time point t9.

Referring to FIGS. 3B and 4B, the real-time value RTV generated by the real-time value generation module 135 of FIG. 1 is illustrated in FIG. 4B. In an example embodiment, the real-time value generation module 135 may generate the real-time value RTV based on the time gray code TGC. In an example embodiment, the real-time value generation module 135 may change or update the real-time value RTV depending on changes in the time gray code TGC. For example, when the time gray code TGC increases compared to the previous value, the real-time value generation module 135 may increase the real-time value RTV by the first interval INT1, and when the time gray code TGC decreases compared to the previous value, the real-time value generation module 135 may increase the real-time value RTV by the second interval INT2. In an example embodiment, the first interval INT1 may be equal to the period of the first clock signal CLK1 or may correspond to the period of the first clock signal CLK1. In an example embodiment, the second interval INT2 may be equal to the period of the second clock signal CLK2 or may correspond to the period of the second clock signal CLK2.

At the sixth time point t6, the real-time value generation module 135 may update the real-time value RTV by the second interval INT2 in response to the decrease in the time gray code TGC. The real-time value RTV may be a sixth real-time value RTV6 at the sixth time point t6. The real-time value generation module 135 may update the real-time value RTV by the second interval INT2 in response to the decrease in the time gray code TGC until immediately after the eighth time point t8. At the eighth time point t8, the real-time value RTV may be an eighth real-time value RTV8.

The real-time value generation module 135 may update the real-time value RTV in response to the increase in the time gray code TGC at the ninth time point t9. The real-time value generation module 135 may change or update the real-time value RTV to a ninth real-time value RTV9 by increasing the real-time value RTV by the first interval INT1 at the ninth time point t9. Likewise, the real-time value generation module 135 may update the real-time value RTV by increasing the real-time value RTV by the first interval INT1 in response to the time gray code TGC increasing. At the eleventh time point t11, the real-time value RTV may be an eleventh real-time value RTV11.

As shown in FIGS. 3A to 4B, the real-time value generation module 135 may detect the mode of the clock signal (CLK1, CLK2) based on the increase or decrease in the time gray code TGC. In an example embodiment, the real-time value generation module 135 may determine an increase interval of the real-time value RTV depending on the mode of the clock signal (CLK1, CLK2). For example, the real-time value generation module 135 may increase the real-time value RTV by the first interval INT1 in response to increasing the time gray code TGC as the clock signal (CLK1, CLK2) is the first clock signal CLK1, and the real-time value generation module 135 may increase the real-time value RTV by the second interval INT2 in response to decreasing the time gray code TGC as the clock signal (CLK1, CLK2) is the second clock signal CLK2.

According to the operation of FIGS. 3A to 4B, the time gray code TGC may not flip two bits or more at a time. As the real-time value RTV is a continuously increasing value, the time gray code TGC may indicate the mode of the clock signal (CLK1, CLK2) or the change or update interval of the real-time value RTV through an increase or a decrease. (This is because the real-time value RTV, which indicates the time during which the electronic device 100 actually operates, increases regardless of the decrease in the time gray code TGC.) On the basis of this, it is possible to prevent a plurality of bits of the time gray code TGC from being flipped due to changes in the period of the clock signal (CLK1, CLK2), and to prevent the real-time value generation module 135 from not obtaining (e.g., accurately) the updated time gray code TGC. Accordingly, the real-time value generation module 135 of FIGS. 1 to 4B may stably generate, accumulate, change, or update the real-time value RTV regardless of the period of the clock signal (CLK1, CLK2).

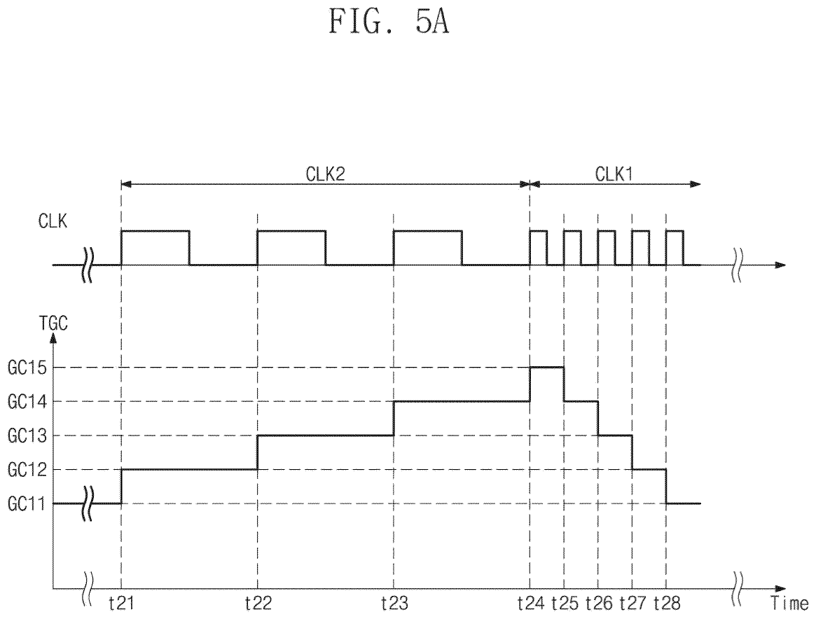

FIG. 5A is a graph showing an example of an operation of the time count block of FIG. 1, according to an example embodiment. FIG. 5B is a graph showing an example of an operation of the real-time value generation module of FIG. 1, according to an example embodiment. Referring to FIGS. 5A and 5B, a horizontal axis may indicate time, and a vertical axis may indicate a signal or a value. According to an example embodiment, an operation of the time count block 120 and an operation of the real-time value generation module 135 are described with reference to FIGS. 1, 5A, and 5B. Among gray codes GC11 to GC15 of FIG. 5A, adjacent gray codes may be different from only one bit.

Referring to FIGS. 1 and 5A, the clock signal (CLK1, CLK2) and the time gray code TGC are illustrated. For example, the clock signal (CLK1, CLK2) may be the second clock signal CLK2 having a second period initially, and may be the first clock signal CLK1 having a first period from a 24th time point t24, depending on the mode change at the 24th time point t24. Here, the second period may be a longer time than the first period. The time gray code TGC may be changed or updated in response to the rising edge of the clock signal (CLK1, CLK2).

In an example embodiment, the time gray code TGC may be increased or decreased depending on the mode of the clock signal (CLK1, CLK2). For example, (e.g., unlike FIGS. 3A to 4B) the time gray code TGC may be updated based on that fact that it decreases in response to the rising edge of the first clock signal CLK1 and increases in response to the rising edge of the second clock signal CLK2.

For example, the time gray code TGC may initially have an eleventh gray code CG11. The time gray code TGC may sequentially increase in response to the clock signal (CLK1, CLK2) being the second clock signal CLK2 and the rising edge of the clock signal (CLK1, CLK2). At the 24th time point t24, the time gray code TGC may be updated to become a fifteenth gray code GC15.

At the 24th time point t24, the mode of the clock signal (CLK1, CLK2) may be changed, and the clock signal (CLK1, CLK2) may be the first clock signal CLK1. The time count block 120 may decrease the time gray code TGC in response to the rising edge of the first clock signal CLK1 from a 25th time point t25. For example, the time count block 120 may be changed or updated to a fourteenth gray code CG14 by decreasing the time gray code TGC by 1 at the 25th time point t25. The time count block 120 may update the time gray code TGC to an eleventh gray code GC11 at a 28th time point t28 in response to the rising edge of the first clock signal CLK1.

Referring to FIG. 5B, the real-time value RTV generated by the real-time value generation module 135 of FIG. 1 is illustrated. In an example embodiment, the real-time value generation module 135 may generate the real-time value RTV based on the time gray code TGC. In an example embodiment, the real-time value generation module 135 may change or update the real-time value RTV depending on changes in the time gray code TGC. For example, when the time gray code TGC increases compared to the previous value, the real-time value generation module 135 may increase the real-time value RTV by the second interval INT2, and when the time gray code TGC decreases compared to the previous value, the real-time value generation module 135 may increase the real-time value RTV by the first interval INT1. In an example embodiment, the first interval INT1 may be equal to the period of the first clock signal CLK1 or may correspond to the period of the first clock signal CLK1. In an example embodiment, the second interval INT2 may be equal to the period of the second clock signal CLK2 or may correspond to the period of the second clock signal CLK2.

For example, the real-time value RTV may be a 21st real-time value RTV21 at a 21st time point t21. The real-time value generation module 135 may increase the real-time value RTV by the second interval INT2 in response to the increase in the time gray code TGC at a 22nd time point t22. The real-time value RTV may be a 22nd real-time value RTV22 at the 22nd time point t22. The real-time value generation module 135 may update or change the real-time value RTV by the second interval INT2 depending on the rising edge of the second clock signal CLK2 until immediately after the 24th time point t24. The real-time value RTV may have a 24th real-time value RTV24 at the 24th time point t24.

At the 24th time point t24, the mode of the clock signal (CLK1, CLK2) may be changed, and the real-time value generation module 135 may change or update the real-time value RTV by the first interval INT1 in response to the decrease in the time gray code TGC from the 25th time point t25. For example, the real-time value generation module 135 may change or update the real-time value RTV to a 25th real-time value RTV25 by increasing the real-time value RTV by the first interval at the 25th time point t25. The real-time value generation module 135 may increase the real-time value RTV by the first interval INT1 in response to the rising edge of the first clock signal CLK1. The real-time value RTV may be a 28th real-time value RTV28 at the 28th time point t28.

In FIG. 5B, the real-time value generation module 135 may change or update the real-time value RTV regardless of the mode change of the clock signal (CLK1, CLK2) by changing the increase interval of the real-time value RTV depending on the change form of the time gray code TGC. In this regard, the real-time value generation module 135 may generate the real time, at which the electronic device 100 operates, regardless of the period of the clock signal (CLK1, CLK2) changing depending on a mode change of the clock signal (CLK1, CLK2). As shown in FIG. 5B, the real-time values RTV21 to RTV28 may correspond to time points t21 to t28, respectively.

As described through FIGS. 3A to 5B, the real-time value generation module 135 may set an interval for changing or updating the real-time value RTV depending on whether the time gray code TGC increases or decreases. Accordingly, the time count block 120 may generate a gray code corresponding to a clock signal CLK (e.g., the first clock signal CLK1, and the second clock signal CLK2) with two periods, based on flipping only one bit among a plurality of bits. Accordingly, unlike a case where the time gray code TGC only increases, a case where two or more bits of the time gray code TGC are simultaneously flipped may be excluded.

In FIGS. 3A to 5B, an example embodiment in which the time count block 120 and the real-time value generation module 135 operate in response to the same time point is described, but the scope of the present disclosure is not limited thereto. In an example embodiment, there may be a delay between the time points of FIGS. 3B, 4B, and 5B and the corresponding time points of FIGS. 3A, 4A, and 5A (e.g., due to data transmission time, or the time required to generate the real-time value RTV). For example, there may be a delay between the first time point t1 in FIG. 3A and the first time point t1 in FIG. 3B, and the delay may be due to communication between the time count block 120 and the real-time value generation module 135 or the operation of the real-time value generation module 135. In an example embodiment, delays between the time points of FIGS. 3B, 4B, and 5B and the corresponding time points of FIGS. 3A, 4A, and 5A may be (e.g., substantially) identical to one another. In FIGS. 3A to 5B, an example in which the time gray code TGC changes in response to the rising edge of the clock signal (CLK1, CLK2) is described, but the scope of the present disclosure is not limited thereto. In an example embodiment, the time gray code TGC may be changed in response to the falling edge of the clock signal (CLK1, CLK2).

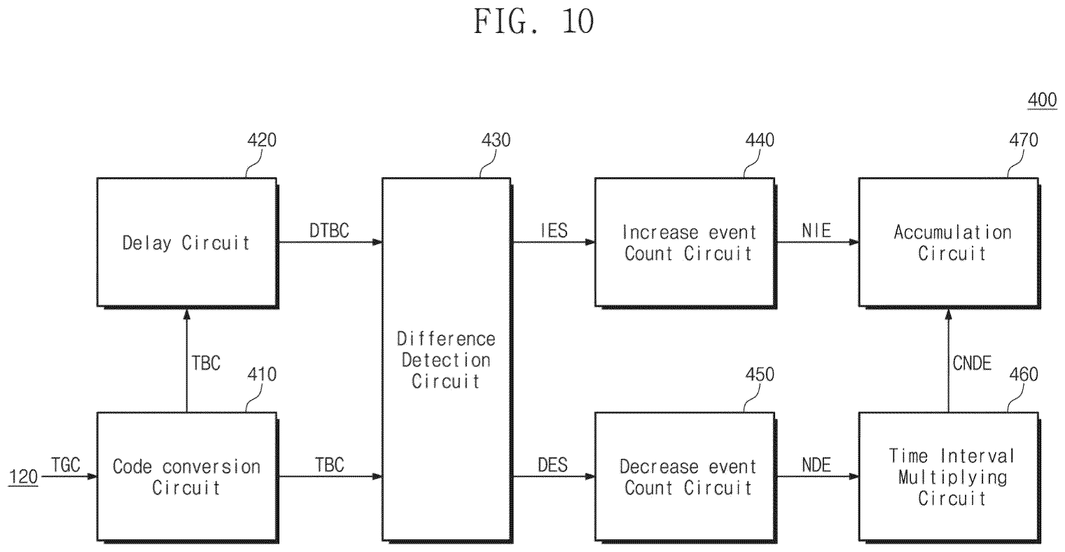

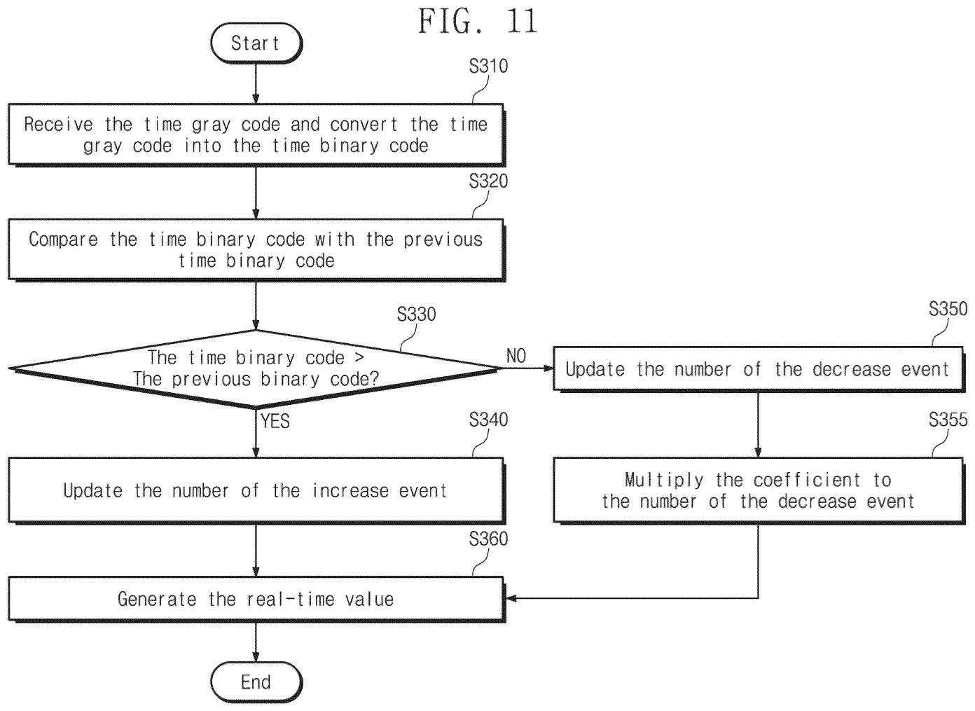

In FIGS. 3A to 5B, an example embodiment in which the real-time value generation module 135 changes the real-time value RTV by intervals (e.g., the first interval INT1 or the second interval INT2) corresponding to the change in the time gray code TGC by detecting an increase or a decrease in the time gray code TGC. However, the scope of the present disclosure is not limited thereto. The real-time value generation module 135 may generate a first number of events indicating a number of times the time gray code TGC increases, and a second number of events indicating a number of times the time gray code TGC decreases, and may generate the real-time value RTV by adding the product of the first number and the time (or interval) corresponding to the increase event, and the product of the second number and the time (or interval) corresponding to the decrease event. An example embodiment in which the real-time value generation module 135 generates the real-time value RTV based on the number of events is described in more detail with reference to FIGS. 10 and 11. For example, referring to FIGS. 3A and 3B, until immediately after the seventh time point t7, the real-time value generation module 135 may calculate the number of events, in which the time gray code TGC increases, as 5 and may calculate the number of events, in which the time gray code TGC decreases, as 2. In this case, the real-time value generation module 135 may generate, accumulate, change, or update the seventh real-time value RTV7 corresponding to the seventh time point t7 based on adding a real-time value corresponding to five increase events and a real-time value corresponding to two decrease events.

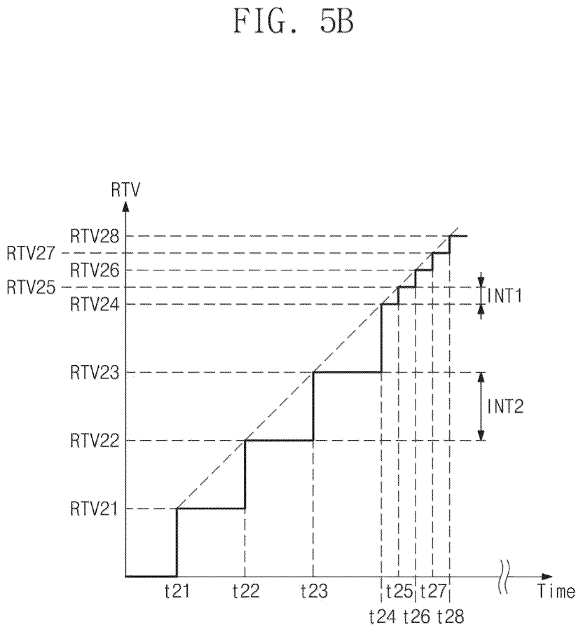

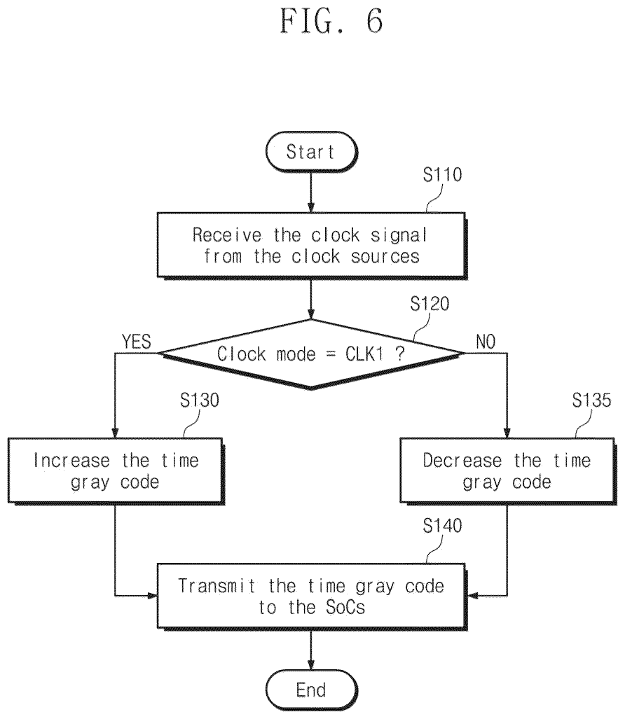

FIG. 6 is a flowchart showing an operating method of the time count block of FIG. 1, according to an example embodiment. An operating method of the time count block 120 according to an example embodiment is described with reference to FIGS. 1 to 6.

Referring to FIG. 1, and 3A to 6, in operation S110, the time count block 120 may receive the clock signal (CLK1, CLK2). In an example embodiment, the time count block 120 may receive the clock signal (CLK1, CLK2) from the clock signal generation block 110. In an example embodiment, the time count block 120 may further receive the mode signal MS related to the operating mode of the electronic device 100. For example, the time count block 120 may receive the clock signal (CLK1, CLK2) from the clock signal generation block 110, and may further receive the mode signal MS from the function block 130.

In operation S120, the time count block 120 determines the mode of the clock signal (CLK1, CLK2) and may determine the next operation. In an example embodiment, the time count block 120 may determine the mode of the clock signal (CLK1, CLK2) based on detecting the period of the clock signal (CLK1, CLK2). In an example embodiment, the time count block 120 may determine the mode of the clock signal (CLK1, CLK2) based on the mode signal MS received in operation S110.

In an example embodiment, the clock signal (CLK1, CLK2) may include the first clock signal CLK1 and the second clock signal CLK2. The first clock signal CLK1 may correspond to a first mode (e.g., a normal mode) of the electronic device 100, and the second clock signal CLK2 may correspond to a second mode (e.g., a sleep mode) of the electronic device 100. When the clock signal (CLK1, CLK2) is the first clock signal CLK1, the time count block 120 may proceed to operation S130. On the other hand, when the clock signal (CLK1, CLK2) is the second clock signal CLK2, the time count block 120 may proceed to operation S135.

In operation S130 and operation S135, the time count block 120 may change or update the time gray code TGC. In an example embodiment, the time count block 120 may change or update the time gray code TGC in response to the rising edge of the clock signal (CLK1, CLK2). In operation S130, the time count block 120 may increase the time gray code TGC. In an example embodiment, the time count block 120 may increase the time gray code TGC by 1 in response to the rising edge of the clock signal (CLK1, CLK2). In operation S135, the time count block 120 may decrease the time gray code TGC. In an example embodiment, the time count block 120 may decrease the time gray code TGC by 1 in response to the rising edge of the clock signal (CLK1, CLK2).

An example embodiment, in which the time count block 120 increases the time gray code TGC in operation S130 and decreases the time gray code TGC in operation S135, is described. However, the scope of the present disclosure is not limited thereto. On the other hand, it should also be understood that an example embodiment, in which the time count block 120 decreases the time gray code TGC in operation S130 and increases the time gray code TGC in operation S135, is also within the scope of the present disclosure.

In operation S140, the time count block 120 may transmit the time gray code TGC to the function block 130. In an example embodiment, the time count block 120 may transmit the time gray code TGC to the real-time value generation module 135. For example, the time count block 120 may transmit the time gray code TGC to the real-time value generation module 135 of the function block 130. The time count block 120 may terminate the operation after operation S140 ends, or return to operation S110.

In FIG. 6, at least some of the operations may be performed simultaneously or to be overlapped. For example, the time count block 120 may receive a new clock signal (CLK1, CLK2) (e.g., the rising edge of the clock signal (CLK1, CLK2)) simultaneously with the execution of operation S120. That is, the time count block 120 may receive the clock signal (CLK1, CLK2) while changing or updating the time gray code TGC.

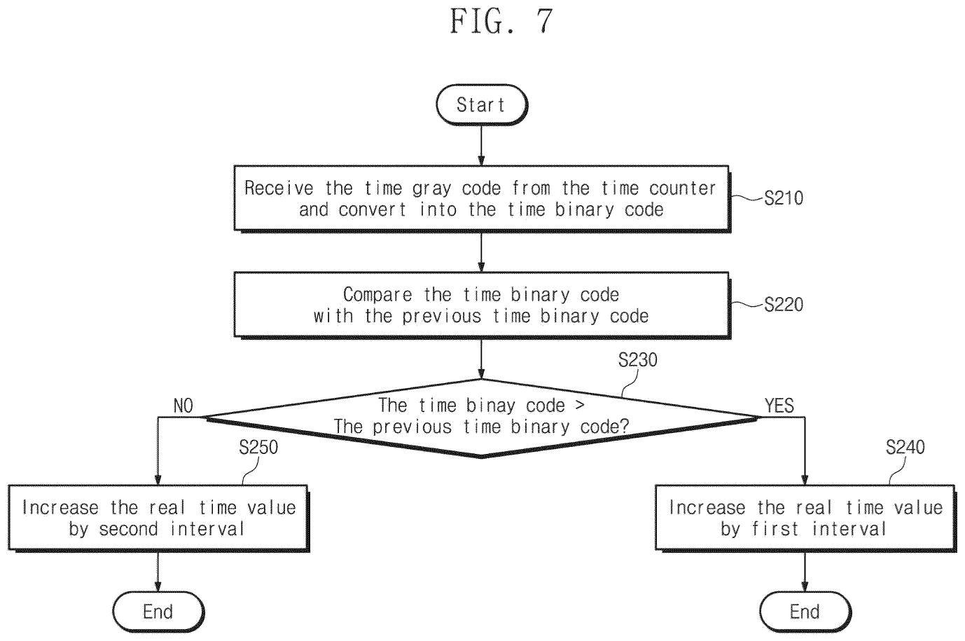

FIG. 7 is a flowchart showing an operating method of the real-time value generation module 135 of FIG. 1, according to an example embodiment. An operating method of the real-time value generation module 135 according to an example embodiment is described with reference to FIGS. 1, 3A to 5B, and 7.

In operation S210, the real-time value generation module 135 may convert the received time gray code TGC into a time binary code. In an example embodiment, the real-time value generation module 135 may convert the time gray code TGC into a time binary code based on logical operations. For example, the real-time value generation module 135 may perform logical operations on bits of the time gray code TGC received from the time count block 120 and may generate the time binary code. In operation S210, a value indicated by the generated time binary code may be the same as a value indicated by the time gray code TGC.

In operation S220, the real-time value generation module 135 may compare the time binary code with a previous time binary code. In an example embodiment, the real-time value generation module 135 may compare the time binary code with the previous time binary code. For example, the real-time value generation module 135 may compare the time binary code with the previous time binary code and may determine whether the time binary code has increased or decreased compared to the previous time binary code.

In operation S230, the real-time value generation module 135 may determine the next operation based on the comparison result between the time binary code and the previous (or immediately preceding) time binary code. When the time binary code is greater than the previous (or immediately preceding) time binary code, the real-time value generation module 135 may proceed to operation S240. When the time binary code is less than the previous (or immediately preceding) time binary code, the real-time value generation module 135 may proceed to operation S250.

In operation S240 and operation S250, the real-time value generation module 135 may change or update the real-time value. In operation S240, the real-time value generation module 135 may increase the real-time value by a first interval (e.g., the first interval INT1 in FIG. 3B). In an example embodiment, the first interval may correspond to the period of the first clock signal. In operation S250, the real-time value generation module 135 may increase the real-time value by a second interval (e.g., the second interval INT2 in FIG. 3B). In an example embodiment, the second interval may correspond to the period of the second clock signal.

In FIG. 7, an example embodiment in which the real-time value RTV increases by the first interval in operation S240 and the real-time value RTV increases by the second interval in operation S250 is described. However, the scope of the present disclosure is not limited thereto. It should be understood that an example embodiment in which the real-time value RTV increases by the second interval in operation S240 and the real-time value RTV increases by the first interval in operation S250, depending on the form of increase or decrease in the time gray code TGC (i.e., depending on a clock mode (the period of a clock signal) in which the time gray code TGC increases or decreases), may be within the scope of the present disclosure.

The real-time value generation module 135 may terminate an operation after operation S240 or operation S250 ends, or may return to operation S210. In an example embodiment, at least some of the operations of FIG. 7 may be performed simultaneously or to be overlapped. For example, the real-time value generation module 135 may perform the real-time value change or update operation of operations S230 to S250 while receiving the new time gray code TGC.

In FIG. 7, at least some of the operations may be performed simultaneously or to be overlapped. For example, the real-time value generation module 135 may perform operation S210 on the new time gray code TGC while performing operation S240. The time count block 120 and the real-time value generation module 135 of FIGS. 6 and 7 may continuously generate a real-time value (e.g., without an error) regardless of the mode change of the clock signal (CLK1, CLK2).

FIG. 8 is a block diagram showing an example of a clock signal generation block of FIG. 1, according to an example embodiment. A clock signal generation block 200 may correspond to the clock signal generation block 110 of FIG. 1. Referring to FIG. 8, the clock signal generation block 200 may include a first clock generation circuit 210, a second clock generation circuit 220, and a clock selection circuit 230. The clock signal generation block 200 according to an example embodiment is described with reference to FIG. 8.

Referring to FIGS. 1 and 8, the clock generation circuits 210 and 220 may generate a clock signal. In an example embodiment, the clock generation circuits 210 and 220 may generate clock signals of different periods. For example, the first clock generation circuit 210 may generate the first clock signal CLK1 having a first period, and the second clock generation circuit 220 may generate the second clock signal CLK2 having a second period.

In an example embodiment, the first clock signal CLK1 and the second clock signal CLK2 may be clock signals used for different operating modes of the electronic device 100. For example, the first clock signal CLK1 may be used in a first mode (e.g., a normal mode) of the electronic device 100, and the second clock signal CLK2 may be used in a second mode (e.g., a sleep mode or a power-saving mode) of the electronic device 100. Here, the first period of the first clock signal CLK1 may be shorter than the second period of the second clock signal CLK2. That is, the period of the clock signal used in the operating mode of the electronic device 100 may be shorter than the period of the clock signal used in the sleep mode or power-saving mode of the electronic device 100.

The clock selection circuit 230 may select the first clock signal CLK1 or the second clock signal CLK2 to be output by the clock signal generation block 200. In an example embodiment, the clock selection circuit 230 may select the clock signal (CLK1, CLK2) to be output in response to the mode signal MS. For example, the clock selection circuit 230 may output one of the first clock signal CLK1 and the second clock signal CLK2, depending on the mode signal MS. In an example embodiment, the clock selection circuit 230 may provide the clock signal (CLK1, CLK2) to different configurations of the electronic device 100. For example, the clock selection circuit 230 may provide the clock signal (CLK1, CLK2) to the time count block 120 or the function block 130.

In FIG. 8, an example embodiment in which the clock signal generation block 200 includes two clock generation circuits 210 and 220 is described, but the scope of the present disclosure is not limited thereto. It should be understood that an example embodiment including one or more clock generation blocks capable of generating clock signal(s) having a period other than the first clock signal CLK1 and the second clock signal CLK2 is also within the scope of the present disclosure.

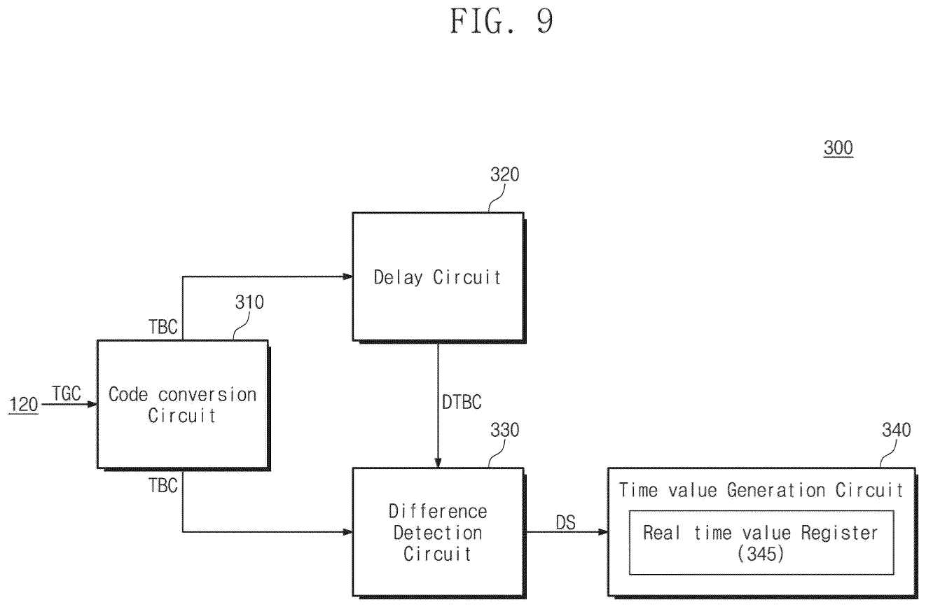

FIG. 9 is a block diagram showing in detail an example of a real-time value generation module of FIG. 1, according to an example embodiment. A real-time value generation module 300 may correspond to the real-time value generation module 135 of FIG. 1. Referring to FIG. 9, the real-time value generation module 300 may include a code conversion circuit 310, a delay circuit 320, a difference detection circuit 330, and a time value generation circuit 340.

The code conversion circuit 310 may receive the time gray code TGC and may convert the time gray code TGC into a time binary code TBC. A magnitude (or size) of the converted time binary code TBC may be the same as a magnitude (or size) of the time gray code TGC. In an example embodiment, the code conversion circuit 310 may receive the time gray code TGC from the time count block 120 of FIG. 1.

In an example embodiment, the code conversion circuit 310 may generate the time binary code TBC based on a logical operation between bits of the time gray code TGC. For example, the code conversion circuit 310 may perform a logical operation between bits of the time gray code TGC received from the time count block 120 of FIG. 1, and may generate the time binary code TBC based on the operation result. The code conversion circuit 310 may deliver the generated time binary code TBC to the delay circuit 320 and the difference detection circuit 330.

The delay circuit 320 may receive the time binary code TBC and may generate a delayed time binary code DTBC based on the received time binary code TBC. In an example embodiment, the delay circuit 320 may generate the delayed time binary code DTBC based on delaying the time binary code TBC by a target delay time. For example, until the next time binary code TBC is delivered to the difference detection circuit 330, the delay circuit 320 may delay the received time binary code TBC. For example, the delay circuit 320 may delay the time binary code TBC by the same time as (e.g., substantially) the period of the clock signal (CLK1, CLK2). In an example embodiment, the delay circuit 320 may generate the delayed time binary code DTBC at the timing when the next time binary code TBC is delivered to the difference detection circuit 330. The delay circuit 320 may deliver the generated delayed time binary code DTBC to the difference detection circuit 330.

The difference detection circuit 330 may detect or determine a change (e.g., increase or decrease) in the time gray code TGC. The difference detection circuit 330 may generate a difference signal DS based on detecting or determining the change in the time gray code TGC. In an example embodiment, the difference detection circuit 330 may detect a change (e.g., increase or decrease) in the time gray code TGC based on detecting a change (e.g., increase or decrease) in the time binary code TBC. (As the time binary code TBC and the time gray code TGC correspond to each other and have the same magnitude as each other, a change in the time binary code TBC may be the same as a change in the time gray code TGC.) For example, when the difference detection circuit 330 detects or determines that the time binary code TBC has increased, the difference detection circuit 330 may also determine that the time gray code TGC has increased, and may generate the difference signal DS based on the detection or determination.

In an example embodiment, the difference detection circuit 330 may determine an increase or a decrease in the time binary code TBC based on a comparison between the time binary code TBC and the delayed time binary code DTBC. For example, the difference detection circuit 330 may calculate the difference between the time binary code TBC and the delayed time binary code DTBC, and may detect an increase or a decrease in the time binary code TBC based on the calculated difference. An increase or a decrease in the time binary code TBC may correspond to an increase or a decrease in the time gray code TGC.

The difference signal DS or information included in the difference signal DS may vary depending on the change form of the time gray code TGC. In an example embodiment, the difference signal DS or the information included in the difference signal DS may be determined depending on an increase or a decrease in the time binary code TBC or the time gray code TGC. For example, when the time gray code TGC increases in response to the first clock signal CLK1, the difference detection circuit 330 may detect that the time binary code TBC has increased, and may generate the difference signal DS including information about the real-time value increasing by a first interval corresponding to the first clock signal CLK1.

For a more detailed example, referring to FIGS. 3A and 3B, the difference detection circuit 330 may detect that the time gray code TGC has increased (e.g., based on the comparison between the time binary code TBC and the delayed time binary code DTBC), and may generate the difference signal DS including information about the real-time value RTV increasing by the first interval INT1, based on the detection. Here, the first interval INT1 may correspond to the period of the first clock signal CLK1. Likewise, referring to FIGS. 3A and 3B, the difference detection circuit 330 may detect that the time gray code TGC has decreased (e.g., based on the comparison between the time binary code TBC and the delayed time binary code DTBC), and may generate the difference signal DS including information about the real-time value RTV increasing by the second interval INT2 corresponding to the period of the second clock signal CLK2, based on the detection. Here, the second interval INT2 may correspond to the period of the second clock signal CLK2.

For another more detailed example, referring to FIGS. 5A and 5B, the difference detection circuit 330 may detect that the time gray code TGC has decreased (based on the comparison between the time binary code TBC and the delayed time binary code DTBC), and may generate the difference signal DS including information about the real-time value RTV increasing by the first interval INT1, based on the detection. Here, the first interval INT1 may correspond to the period of the first clock signal CLK1. Likewise, referring to FIGS. 5A and 5B, the difference detection circuit 330 may detect that the time gray code TGC has increased (based on the comparison between the time binary code TBC and the delayed time binary code DTBC), and may generate the difference signal DS including information about the real-time value RTV increasing by the second interval INT2, based on the detection. Here, the second interval INT2 may correspond to the period of the second clock signal CLK2. For convenience of description, the present disclosure is described based on FIGS. 3A and 5A, but this is an example and the scope of the present disclosure is not limited thereto.

The time value generation circuit 340 may generate, change, or update a real-time value (e.g., the real-time value RTV of FIGS. 3B, 4B, or 5B) in response to the difference signal DS. In an example embodiment, the time value generation circuit 340 may change or update a real-time value based on update information included in the difference signal DS. For example, the time value generation circuit 340 may change or update the real-time value based on information about the real-time value included in the difference signal DS increasing by the first interval, or information about the real-time value increasing by the second interval. For example, the difference signal DS corresponding to the first clock signal CLK1 may include real-time value increase information of the first interval. The time value generation circuit 340 may increase the real-time value RTV by the first interval in response to the difference signal DS (e.g., as shown in FIG. 3B). For example, the difference signal DS corresponding to the second clock signal CLK2 may include real-time value increase information of the second interval. The time value generation circuit 340 may increase the real-time value RTV by the second interval in response to the difference signal DS (e.g., as in FIG. 3B).

In an example embodiment, the time value generation circuit 340 may include a real-time value register 345 that stores a real-time value. In an example embodiment, the real-time value register 345 may include a memory. For example, the real-time value register 345 may include a volatile memory (e.g., a dynamic random access memory (DRAM) or a static RAM (SRAM)) or one or more flip-flops. In the time value generation circuit 340, the generated real-time value (e.g., the real-time value RTV of FIGS. 3B, 4B, and 5B) may be used for the operation of the SoC (e.g., the function block 130 of FIG. 1).

It should be understood that the real-time value generation module 300 described with reference to FIG. 9 is an example. An example embodiment in which the real-time value generation module 300 does not include at least some of the configurations of FIG. 9 is within the scope of the present disclosure. In an example embodiment, the real-time value generation module 300 may not include the code conversion circuit 310. For example, the delay circuit 320 and the difference detection circuit 330 may receive the time gray code TGC, and the difference detection circuit 330 may detect an increase or a decrease in the time gray code TGC.

FIG. 10 is a block diagram showing in detail an example of a real-time value generation module of FIG. 1, according to an example embodiment. A real-time value generation module 400 may correspond to the real-time value generation module 135 of FIG. 1. Referring to FIG. 10, the real-time value generation module 400 may include a code conversion circuit 410, a delay circuit 420, a difference detection circuit 430, an increase event count circuit 440, a decrease event count circuit 450, a time interval multiplying circuit 460, and an accumulation circuit 470. The real-time value generation module 400 according to an example embodiment is described with reference to FIGS. 1 to 5B and 10.

The code conversion circuit 410 may receive the time gray code TGC and may convert the received time gray code TGC into the time binary code TBC. In an example embodiment, the code conversion circuit 410 may receive the time gray code TGC from the time count block 120. The code conversion circuit 410 may be identical or similar to the code conversion circuit 310 of FIG. 9, and may operate identically or similarly to the operation of the code conversion circuit 310 of FIG. 9. The code conversion circuit 410 may provide the generated time binary code TBC to the delay circuit 420 or the difference detection circuit 430. The magnitude of the time binary code TBC may be the same as the magnitude of the time gray code TGC.

The delay circuit 420 may receive the time binary code TBC and may generate the delayed time binary code DTBC. In an example embodiment, the delay circuit 420 may generate the delayed time binary code DTBC by delaying the time binary code TBC by a target delay time. The delay circuit 420 may be identical to or similar to the delay circuit 320 of FIG. 9, and may operate identically or similarly to the operation of the delay circuit 320 of FIG. 9. The delay circuit 420 may provide the generated delayed time binary code DTBC to the difference detection circuit 430.

The difference detection circuit 430 may detect or determine a change in the time gray code TGC. In an example embodiment, the difference detection circuit 430 may detect or determine the change in the time gray code TGC based on detecting or determining a change in the time binary code TBC. In an example embodiment, the difference detection circuit 430 may detect or determine an increase or a decrease in the time gray code TGC based on a comparison between the time binary code TBC and the delayed time binary code DTBC. The difference detection circuit 430 may detect or determine an increase or a decrease in the time gray code TGC in the identical or similar manner to the detection of the time gray code TGC of the difference detection circuit 330 of FIG. 9.

In an example embodiment, the difference detection circuit 430 may generate an increase event signal IES or a decrease event signal DES depending on the change in the time gray code TGC. For example, when detecting or determining that the time gray code TGC has increased, the difference detection circuit 430 may generate the increase event signal IES, and when detecting or determining that the time gray code TGC has decreased, the difference detection circuit 430 may generate the decrease event signal DES.

In an example embodiment, the difference detection circuit 430 may transmit the generated increase event signal IES or the generated decrease event signal DES to other blocks. For example, the difference detection circuit 430 may transmit the increase event signal IES to the increase event count circuit 440, and the difference detection circuit 430 may transmit the decrease event signal DES to the decrease event count circuit 450.

The increase event count circuit 440 may count the number of increase events NIE of the time gray code TGC. The number of increase events NIE may indicate the number of events at which the time gray code TGC or the time binary code TBC increases. In an example embodiment, the increase event count circuit 440 may count or manage the number of increase events NIE of the time gray code TGC using a counter. In an example embodiment, the increase event count circuit 440 may change or update the value of the counter in response to the increase event signal IES. For example, the increase event count circuit 440 may manage the counter that changes or updates the value in response to the increase event signal IES. The counter may output the number of increase events NIE. The increase event count circuit 440 may deliver the generated number of increase events NIE to the accumulation circuit 470.

The decrease event count circuit 450 may count the number of decrease events NDE of the time gray code TGC. The number of decrease events NDE may indicate the number of events at which the time gray code TGC or the time binary code TBC decreases. In an example embodiment, the decrease event count circuit 450 may count or manage the number of decrease events NDE of the time gray code TGC based on a counter. In an example embodiment, the decrease event count circuit 450 may change or update the value of the counter in response to the decrease event signal DES. For example, the decrease event count circuit 450 may manage the counter that changes or updates the value in response to the decrease event signal DES. The counter may output the number of decrease events NDE. The decrease event count circuit 450 may deliver the generated number of decrease events NDE to the time interval multiplying circuit 460.

In an example embodiment, a minimum change amount of the number of increase events NIE or the number of decrease events NDE, a range or degree to which it is changed or updated at one time, a minimum unit value, or resolution of a value may be a value corresponding to the period of one of the clock signals CLK1 and CLK2. For example, the minimum change of a value (or the resolution of a value) of each of the number of increase events NIE or the number of decrease events NDE may correspond to a time corresponding to the period of the first clock signal CLK1 in FIG. 3A. That is, the number of increase events NIE may correspond to the period of the first clock signal CLK1. The number of increase events NIE increasing by 1 may correspond to the time of one period of the first clock signal CLK1.

The time interval multiplying circuit 460 may receive the number of decrease events NDE and generate the converted number of decrease events CNDE. In an example embodiment, the time interval multiplying circuit 460 may multiply a period of a clock signal corresponding to a decrease in the time gray code TGC by the number of decrease events NDE. For example, referring to FIGS. 3A and 10, the time interval multiplying circuit 460 may multiply a value corresponding to a period of the second clock signal CLK2 by the number of decrease events NDE, and may generate the converted number of decrease events CNDE based on the multiplication result.

In an example embodiment, the converted number of decrease events CNDE may correspond to a clock signal of a period among the clock signals CLK1 and CLK2. For example, referring to FIG. 3B, the converted number of decrease events CNDE may correspond to the product of the period of the second clock signal CLK2 and the number of the rising edges of the second clock signal CLK2. The time interval multiplying circuit 460 may deliver the converted number of decrease events CNDE to the accumulation circuit 470. That is, a minimum change amount of the converted number of decrease events CNDE, a range or degree to which it is changed or updated at one time, a minimum unit value, or resolution of a value may be a value corresponding to the period of the other clock signal (e.g., the second clock signal CLK2) among the clock signals CLK1 and CLK2.

The accumulation circuit 470 may generate a real-time value (e.g., the real-time value RTV in FIG. 3B) based on the received values (i.e., the number of increase events NIE and the converted number of decrease events CNDE). In an example embodiment, the accumulation circuit 470 may generate the real-time value based on summing the received values. For example, the accumulation circuit 470 may generate a real-time value by summing or accumulating the number of increase events NIE and the converted number of decrease events CNDE.

The real-time value generation module 400 of FIG. 10 may generate the real-time value based on the number of events, in which the time gray code TGC increases, and the number of events at which the time gray code TGC decreases. In FIG. 10, an example embodiment in which the time interval multiplying circuit 460 receives and converts the number of decrease events NDE from the decrease event count circuit 450 is described, but the scope of the present disclosure is not limited thereto. In an example embodiment, the time interval multiplying circuit 460 may receive and convert the number of increase events NIE. In this case, the accumulation circuit 470 may generate the real-time value based on the number of decrease events NDE and the converted number of increase events.

It should be understood that the configurations of FIG. 10 are examples. An example embodiment, in which some of the described configurations are not included, is within the scope of the present disclosure. In an example embodiment, the real-time value generation module 400 may not include the time interval multiplying circuit 460. In this case, the accumulation circuit 470 may receive the number of increase events NIE from the increase event count circuit 440, may receive the number of decrease events NDE from the decrease event count circuit 450, and may generate a real-time value by accumulating times corresponding to each of the number of increase events NIE and the number of decrease events NDE. For example, the accumulation circuit 470 may generate a first real-time value corresponding to the number of increase events NIE, may generate a second real-time value corresponding to the number of decrease events NDE, and may generate a real-time value (e.g., the real-time value of FIG. 3B) by adding or accumulating the first real-time value and the second real-time value.

FIG. 11 is a flowchart showing an example of an operating method of the real-time value generation module of FIG. 10, according to an example embodiment. An example of an operating method of the real-time value generation module 400 according to an example embodiment is described with reference to FIGS. 1 to 5B, 10, and 11.

In operation S310, the real-time value generation module 400 may receive the time gray code TGC and may convert the time gray code TGC into the time binary code TBC. For example, the real-time value generation module 400 may receive the time gray code TGC and may convert the time gray code TGC into the time binary code TBC through the code conversion circuit 410.

In operation S320, the real-time value generation module 400 may compare the time binary code TBC with the previous time binary code. In an example embodiment, the real-time value generation module 400 may generate the delayed time binary code DTBC from the time binary code TBC through the delay circuit 420 and may generate the previous time binary code. In an example embodiment, the real-time value generation module 400 may compare the time binary code TBC with the previous time binary code through the difference detection circuit 430. For example, the real-time value generation module 400 may compare the time binary code TBC and the delayed time binary code DTBC through the difference detection circuit 430.

In operation S330, the real-time value generation module 400 may determine the next operation depending on an increase or a decrease in the time binary code TBC. When the time binary code TBC is greater than the previous time binary code (i.e., the time binary code TBC has increased), the real-time value generation module 400 may proceed to operation S340. When the time binary code TBC is not greater than the previous time binary code (or the time binary code TBC is less than the previous time binary code (i.e., the time binary code TBC has decreased), the real-time value generation module 400 may proceed to operation S350.

In operation S340, the real-time value generation module 400 may increase the number of increase events NIE in response to an increase in the time binary code TBC. The number of increase events NIE may indicate the number of events at which the time gray code TGC or the time binary code TBC increases. In an example embodiment, the real-time value generation module 400 may manage the number of increase events NIE through the increase event count circuit 440. For example, the real-time value generation module 400 may increase the number of increase events NIE in response to the increase in the time binary code TBC through the increase event count circuit 440.

In operation S350, the real-time value generation module 400 may increase the number of decrease events NDE in response to the decrease in the time binary code TBC. In an example embodiment, the real-time value generation module 400 may manage the number of decrease events NDE through the decrease event count circuit 450. For example, the real-time value generation module 400 may increase the number of decrease events NDE in response to the decrease in the time binary code TBC through the decrease event count circuit 450.

In operation S355, the real-time value generation module 400 may multiply a coefficient by the number of decrease events NDE. In an example embodiment, the coefficient may correspond to the period of the clock signal corresponding to a decrease in the time gray code TGC. In an example embodiment, the real-time value generation module 400 may multiply a coefficient by the number of decrease events NDE through the time interval multiplying circuit 460. For example, the real-time value generation module 400 may generate the converted number of decrease events CNDE by multiplying the period of the clock signal corresponding to the decrease of the time gray code TGC by the number of decrease events NDE.

In operation S360, the real-time value generation module 400 may generate a real-time value (e.g., the real-time value RTV in FIG. 3B). In an example embodiment, the real-time value generation module 400 may generate, accumulate, change, or update the real-time value through the accumulation circuit 470. In an example embodiment, the real-time value generation module 400 may generate a real-time value based on the number of increase events NIE and the number of decrease events NDE. For example, the real-time value generation module 400 may generate the real-time value based on the sum or accumulation of the number of increase events NIE and the converted number of decrease events CNDE.

In FIG. 11, it is described that the converted number of decrease events is generated when the time binary code TBC decreases, but the scope of the present disclosure is not limited thereto. It should also be understood that an example embodiment in which a real-time value is generated based on the converted number of increase events generated from the number of decrease events NDE and the number of increase events NIE is within the scope of the present disclosure. Moreover, it should be understood that an example embodiment in which the real-time value generation module 400 generates a first real-time value based on the number of increase events NIE, generates a second real-time value based on the number of decrease events NDE, and then generates a real-time value by adding or accumulating the first real-time value and the second real-time value without including operation S355, is also within the scope of the present disclosure. In FIG. 11, at least some of the operations may be performed simultaneously or to be overlapped. For example, the real-time value generation module 300 may perform operation S330 and operation S310 of receiving and converting the new time gray code TGC simultaneously or may perform some of the operations so as to be overlapped.

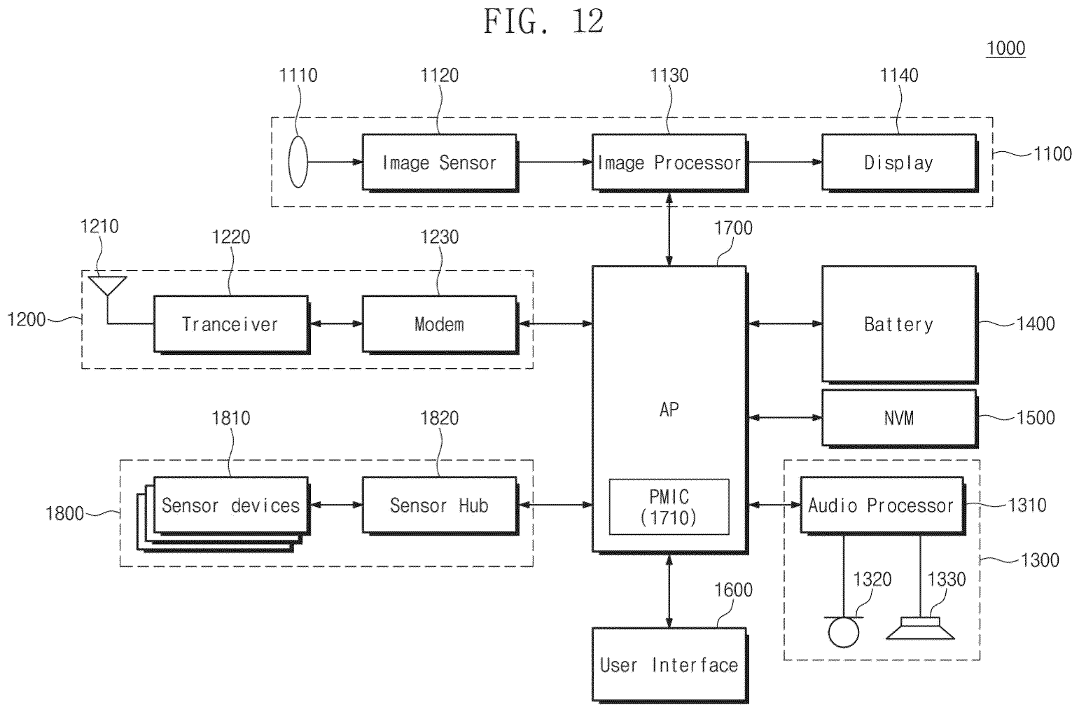

FIG. 12 is a block diagram showing an electronic device 1000, according to an example embodiment. Referring to FIG. 12, the electronic device 1000 according to an example embodiment includes an image processing device 1100, a wireless transceiver device 1200, an audio processing device 1300, a battery 1400, a nonvolatile memory device 1500, a user interface 1600, an application processor (AP) 1700, and a sensor device 1800. Under the control of the AP 1700, the electronic device 1000 may operate.

The image processing device 1100 may include a lens 1110, an image sensor 1120, an image processor 1130, and a display 1140. The image processor 1130 may convert real-world images into image data through the lens 1110 and the image sensor 1120. The display 1140 may display image data signals generated by the image processor 1130 or image data provided to a user. The display 1140 may be composed of a liquid crystal display (LCD) or organic light emitting diodes (OLED). When LCD or OLED is implemented as a touch screen, the display 1140 may also operate together with the user interface 1600.

The wireless transceiver device 1200 includes an antenna 1210, a transceiver 1220, and a modulator/demodulator (modem) 1230. The wireless transceiver device 1200 may perform wireless communication functions. The transceiver 1220 may adjust the frequency of a signal transmitted through the antenna 1210 or amplify the signal, and may adjust the frequency of a signal received through the antenna 1210 or amplify the signal. The modem 1230 may include a sender that encodes and modulates a signal to be transmitted, and a receiver that demodulates and decodes a signal received through the antenna 1210. The antenna 1210 and the modem 1230 of the wireless transceiver device 1200 may process signals exchanged with the external device/system in compliance with at least one of various wireless communication protocols: long term evolution (LTE), worldwide interoperability for microwave access (WiMax), global system for mobile communication (GSM), code division multiple access (CDMA), Bluetooth, near field communication (NFC), wireless fidelity (Wi-Fi), and radio frequency identification (RFID).

The audio processing device 1300 includes an audio processor 1310, a microphone 1320, and a speaker 1330. The audio processing device 1300 may configure a codec, and the codec may include a data codec and an audio codec. The data codec may process packet data, etc., and the audio codec may process audio signals such as voice and multimedia files. Furthermore, the audio processing device 1300 may perform a function of converting a digital audio signal received from the modem 1230 into an analog signal through an audio codec and playing the digital audio signal, or converting an analog audio signal generated from the microphone 1320 into a digital audio signal through an audio codec and transmitting the digital audio signal to the modem 1230. The codec may be provided separately or included in the AP 1700.

The battery 1400 may provide the power required to operate the electronic device 1000. In FIG. 12, the electronic device 1000 is shown as receiving power from the battery 1400, but it should be understood that an example embodiment, in which an external power or an external power source serves as the battery 1400, is also within the scope of the present disclosure. The nonvolatile memory device 1500 may store the data of the electronic device 1000. For example, the nonvolatile memory device 1500 may be or include a NAND flash memory device. The nonvolatile memory device 1500 may be implemented with a memory card (e.g., a MultiMediaCard (MMC), an embedded MMC (eMMC), a Secure Digital (SD) card, or a micro SD card) and the like according to an example embodiment.

The user interface 1600 may receive an input from the outside or may generate an output to the outside. For example, the user interface 1600 may receive an input through a device such as a keyboard, a mouse, or the like. In an example embodiment, the user interface 1600 may include a driver for receiving inputs from devices. In an example embodiment, the user interface 1600 may generate an output by operating in conjunction with the display 1140 or the audio processing device 1300.

The AP 1700 may drive an application program, an operating system, or the like. The AP 1700 may be implemented with a system on chip (SoC) that drives an application program, an operating system, and the like. In an example embodiment, the AP 1700 may include a processor, such as a general-purpose processor or a special-purpose processor. In an example embodiment, the AP 1700 may control configurations of the electronic device 1000. The AP 1700 may include a PMIC 1710. The PMIC 1710 receives a voltage from the battery 1400 and may convert the level of the supplied voltage. The PMIC 1710 may provide the converted voltage level to each configuration of the electronic device 1000.

In an example embodiment, the electronic device 1000 may further include the clock signal generation block 110 of FIGS. 1 to 11 and the time count block 120 of FIGS. 1 to 11. The electronic device 1000 may perform various operations in response to a clock signal of the clock signal generation block 110 of FIGS. 1 to 11. In an example embodiment, the AP 1700 may include the real-time value generation module 135 as described with reference to FIGS. 1 to 11.

The sensor device 1800 may detect various external environments of the electronic device 1000 and may collect data. The sensor device 1800 may include sensor devices 1810 and a sensor hub 1820. The sensor devices 1810 may include various sensors. For example, the sensor devices 1810 may include at least some of a variety of sensors, such as a temperature sensor, a proximity sensor, an infrared sensor, an ultrasonic sensor, an acceleration sensor, an angular acceleration sensor, a pressure sensor, a light sensor, a gas sensor, a gyro sensor, a touch sensor, a humidity sensor, or a flow sensor. The sensor devices 1810 may deliver the sensed results to the sensor hub 1820.

The sensor hub 1820 may generate sensing data based on the sensed results. In an example embodiment, the sensor hub 1820 may include the real-time value generation module 135 of FIGS. 1 to 11. In an example embodiment, the sensor hub 1820 may generate the sensing data based on the sensed results received from the sensor devices 1810 and a real-time value (e.g., the real-time value RTV of FIG. 3B) of the real-time value generation module 135.

The sensor hub 1820 may deliver the sensing data to the AP 1700. In an example embodiment, the sensor hub 1820 may operate under the control of the AP 1700 and may control the sensor devices 1810. For example, the sensor hub 1820 may control the sensor devices 1810 in response to the control of the AP 1700, may generate the sensing data based on the sensed results of the sensor devices 1810 and the real-time values, and may deliver the sensing data to the AP 1700.

The configurations of the electronic device 1000 illustrated in FIG. 12 are examples and the scope of the present disclosure is not limited thereto. For example, the electronic device 1000 may further include a volatile memory device as system memory, and the volatile memory device may operate under the control of the AP 1700. In an example embodiment, the electronic device 1000 may not include some of the configurations of FIG. 12. For example, the electronic device 1000 may not include the image processing device 1100.

The description regarding clock signals CLK1 and CLK2, changes or updates of the time gray code TGC, and changes or updates of the real-time value RTV are provided as examples, and the scope of the present disclosure is not limited thereto. Within the scope of the technical idea of the present disclosure, an example embodiment in which the clock signal (CLK1, CLK2) is changed differently from the form illustrated and described in FIGS. 3A to 5B, an example embodiment in which the time gray code TGC is changed, updated, or transitioned in response to the clock signal (CLK1, CLK2) differently from the form illustrated and described in FIGS. 3A to 5B, or an example embodiment in which the real-time value RTV is changed, updated, or transitioned differently from the form illustrated and described in FIGS. 3A to 5B should be understood to be within the scope of the present disclosure.

While aspects of example embodiments have been particularly shown and described, it will be understood that various changes in form and details may be made therein without departing from the spirit and scope of the following claims.

1. An electronic device comprising:
a clock signal generation circuit configured to generate a first clock signal of a first period and a second clock signal of a second period, and to selectively output one of the first clock signal and the second clock signal;
a time count circuit configured to increase a time gray code in response to the first clock signal and decrease the time gray code in response to the second clock signal; and
a function circuit configured to generate a real-time value based on the time gray code.

2. The electronic device of claim 1, wherein the first period is shorter than the second period.

3. The electronic device of claim 1, wherein the first period is longer than the second period.

4. The electronic device of claim 2, wherein the clock signal generation circuit is further configured to generate the first clock signal in a normal mode of the electronic device and generate the second clock signal in a sleep mode of the electronic device.

5. The electronic device of claim 4, wherein the function circuit comprises a real-time value generation circuit that is configured to increase the real-time value by a first interval corresponding to the first period in response to an increase in the time gray code.

6. The electronic device of claim 5, wherein the real-time value generation circuit is further configured to increase the real-time value by a second interval corresponding to the second period in response to a decrease in the time gray code.

7. The electronic device of claim 2, wherein the function circuit comprises a real-time value generation circuit which comprises:
a code conversion circuit configured to receive the time gray code and to convert the time gray code into a time binary code;
a difference detection circuit configured to detect a change in the time gray code and to generate a difference signal depending on the change in the time gray code; and
a time value generation circuit configured to change the real-time value based on the difference signal,
wherein a magnitude of a value indicated by the time binary code is identical to a magnitude of a value indicated by the time gray code, and
wherein the time value generation circuit is further configured to increase the real-time value by a second interval corresponding to the second period in response to the difference signal generated by the difference detection circuit indicating a decrease in the time gray code.

8. The electronic device of claim 7, wherein the real-time value generation circuit further comprises a delay circuit configured to generate a delayed time binary code by delaying the time binary code,
wherein the delay circuit is further configured to provide the delayed time binary code to the difference detection circuit, and
wherein the difference detection circuit is further configured to detect a change in the time binary code based on a comparison between the time binary code and the delayed time binary code.

9. The electronic device of claim 7, wherein the time value generation circuit is further configured to increase the real-time value by a first interval corresponding to the first period in response to the difference signal generated by the difference detection circuit indicating an increase in the time gray code.

10. The electronic device of claim 9, wherein the time value generation circuit further comprises a time value register configured to store the real-time value.

11. The electronic device of claim 2, wherein the time count circuit is further configured to receive a mode signal indicating a mode of the electronic device, and determine whether to output the first clock signal or the second clock signal based on the mode signal.

12. A real-time value generation device configured to generate a real-time value, the real-time value generation device comprising:
a code conversion circuit configured to convert a time gray code comprising a plurality of bits into a time binary code;
a difference detection circuit configured to generate an increase event signal in response to detecting an increase in the time gray code, and a decrease event signal in response to detecting a decrease in the time gray code;
a decrease event count circuit configured to identify a number of decrease events indicating a number of times the time gray code decreases, according to the decrease event signal; and
an accumulation circuit configured to generate the real-time value based on the number of decrease events,
wherein the time gray code increases in response to a first clock signal of a first period, and decreases in response to a second clock signal of a second period.

13. The real-time value generation device of claim 12, wherein the first period is shorter than the second period.

14. The real-time value generation device of claim 12, wherein the first period is longer than the second period.

15. The real-time value generation device of claim 12, further comprising an increase event count circuit configured to identify a number of increase events indicating a number of times the time gray code increases, according to the increase event signal,
wherein the accumulation circuit is further configured to generate the real-time value based on the number of increase events.

16. The real-time value generation device of claim 15, wherein the accumulation circuit is further configured to generate the real-time value by adding a first real-time value generated based on the number of decrease events and a second real-time value generated based on the number of increase events, and
wherein the real-time value generation device further comprises a time interval multiplying circuit configured to generate a converted number of decrease events based on a product of the number of decrease events and a coefficient corresponding to the second period.

17. The real-time value generation device of claim 16, wherein a minimum change amount of the number of increase events corresponds to the first period, and
wherein a minimum change amount of the converted number of decrease events corresponds to the second period.

18. A method of operating a real-time value generation device configured to manage a real-time value, the method comprising:
receiving a time gray code that increases in response to a first clock signal of a first period and decreases in response to a second clock signal of a second period;
converting the time gray code into a time binary code indicating a same value;
detecting a change in the time gray code;
detecting a number of increase events indicating a number of times the time gray code increases, and a number of decrease events indicating a number of times the time gray code decreases; and
changing the real-time value based on the number of increase events and the number of decrease events.

19. The method of claim 18, wherein the first period is shorter than the second period.

20. The method of claim 18, further comprising:
generating a converted number of decrease events based on the number of decrease events and a period of the first clock signal; and
generating the real-time value based on the converted number of decrease events and the number of increase events.

21-23. (canceled)
